(19) United States
(12) Patent Application Publication
(10) Pub. No.: US 2016/0042308 A1
(43) Pub. Date: Feb. 11, 2016

(54) Timesly: A Mobile Solution for Attendance Verification Powered by Face Technology

(71) Applicant: Marc Aptakin, Fort Lauderdale, FL (US)

(72) Inventor: Marc Aptakin, Fort Lauderdale, FL (US)

(21) Appl. No.: 14/818,861

(22) Filed: Aug. 5, 2015

Related U.S. Application Data
(60) Provisional application No. 62/034,377, filed on Aug. 7, 2014.

(51) Int. Cl. G06Q 10/06

(52) U.S. Cl. CPC G06Q 10/063114

(57) ABSTRACT

Timesly is an invention that enables business managers to monitor their workforce and ensure accurate Employee compensation through mobile and stationary devices equipped with facial recognition technology and Global Positioning System (GPS) technology. Timesly records an Employee's work start and stop times without running the risk of fraudulent time recording by another Employee or at an unintended work site. Powered by facial recognition technology, Timesly is able to immediately recognize whether an Employee is clocking in for someone else and notify the Manager. Timesly's utility on mobile devices means managers can monitor their Employee workforce at changing or remote work locations. GPS technology permits managers to then verify that time entries are all entered at the designated location. Timesly enables Managers to pay the correct Employee for the assigned work completed at the intended worksite.

This nonprovisional application claims benefit to provisional application No. 62/034,377, filed Aug. 7, 2014.

### BACKGROUND OF THE INVENTION

Managers have always sought to compensate Employees in their workforce for the actual time spent at a work site or completing an assigned task. Typically, an Employee used a punch in clock for work, physically inserting a card through a stationary system or swiping a card or key before a stationary machine to register arrival and departure times. An Employee could also punch in an assigned code to register arrival and leave times. This previous technology forced Managers to trust that their Employees were being honest, taking on significant risk of money loss due to reliance on Employees' self-reporting. The previous technology could not ensure that a particular Employee arrived and left a work site or started and completed a task as stated on his or her time sheet because other fellow Employees could punch the card or swipe the key or card or enter the code on his or her behalf. The previous technology also did not permit attendance verification of Employees and work or task time reconciliation from mobile work or task sites. Timesly does away with this self-reporting of time spent at work or on a task and trust that it was done at the intended work site. Instead, Timelsy works on portable and stationary devices to enable Managers to know when a specific Employee arrived at and left a work site or started and completed a task through the use of facial recognition technology and GPS.

### BRIEF SUMMARY OF THE INVENTION

Timesly provides a technology solution for reconciling Employees' time cards for purposes of compensation. Timesly provides a real-time solution for verifying that an Employee is compensated for the work he or she actually does at the designated work site to complete the job without requiring the Manager to be physically present to verify same. Equipped with facial recognition software and global positioning system technology, Timesly can be downloaded on both portable and stationary devices.

Managers will assign a unique alphanumerical code to each Employee. Timsely's facial recognition software will store an electronic image of each Employee's face that the software will associate with the Employee's unique alphanumerical code. When the Employee arrives to a work site or begins an assigned task, the Employee enters his unique alphanumerical code into the device, whether stationary or portable, and stands before the device to have an image of his face scanned. Timesly's facial recognition software then analyzes the image to determine whether it matches the image it already associates with that alphanumerical code. If there is a match, Timesly records the time scan time as a confirmed work site arrival or task start time. Timesly therefore permits the Manager to confirm that the proper Employee is performing the work assigned without the Manager having to be physically present to confirm this. If the is not a match between the scanned image and the stored image associated with the entered alphanumerical code, the scan time is still recorded, but the Manager is alerted of the discrepancy and left to reconcile same.

When the Employee leaves the worksite or completes a task, he again enters his unique alphanumerical code into the device, and stands before the device to have an image of his face scanned. Timesly's facial recognition software again either confirms that this is the correct Employee or notifies the Manager of a discrepancy to be resolved.

Using Global Positioning System (GPS) technology, Timesly enables Managers to determine the geographic location of the device when an Employee arrives and leaves a work site or starts and stops working on a specific task. This is particularly useful for Employees who perform work at remote locations or whose work sites are changing. Timesly in this instance downloaded on a portable device that can travel with the Employee. The GPS technology alerts the Manager of the device's geographic location to add another level of workforce monitoring as to the Employee's arrival and leave times at a particular work site as well as the Employee's location when starting and completing a task. This again enables the Manager to know that his intended Employee is completing his assigned work at an intended work site without having to physically be at the site to confirm all of this. This frees up the Manager and ensures that compensation is paid to the proper Employee.

Timsely is advantageous for all users, including Managers and Employees. All data as to work time and location is accurately tracked to ensure proper reporting and compensation.

### DETAILED DESCRIPTION OF THE INVENTION

Timesly is a business solution that provides a service that will be available with the same functionality in both portable and stationary format though computer, mobile, and tablet applications. The services and interfaces will be tailored depending on the service user. The two types of users include those evaluating attendance entries, or “Managers,” and those making the attendance entries, or “Employees.” The type of user will also determine what information is necessary to use the service. These services will be provided at a cost to be determined by market forces and demand.

Timesly is a mobile solution for verifying Employees' work attendance through the use of face detection technology. Timesly works on both portable and stationary devices. Using already developed facial recognition technology, Timesly enables a Manager or Managers to determine the exact times any particular Employee arrives and leaves a work site or starts and stops working on a specific task. The use of facial recognition permits verification of attendance of a particular Employee. Knowing the exact times an Employee arrives and leaves a work site or starts and stops working on a specific task enables Managers to accurately reconcile the Employee's work time. Using Global Positioning System (GPS) technology, Timesly enables Managers to determine the geographic location of the device when an Employee arrives and leaves a work site or starts and stops working on a specific task. Knowing the device's geographic location permits verification of the Employee's arrival and leave times at a particular work site as well as the Employee's location when starting and completing a task.

Managers who subscribe to the Timesly service will be given access to its facial recognition capabilities for use at any and all contemplated work sites to determine what times each particular Employee arrives at and leaves the work site or starts and ends a task. Managers who subscribe to the Timesly service can also be given access to its GPS technology to determine the geographical location of each device, whether portable or stationary, when each Employee makes an entry to indicate that he or she has arrived at and left work or started and ended a task. Managers who subscribed to the Timely service will be given access to its Tasks function that permits Managers to create a customizable list of tasks for any particular Employee to complete and access when each task is completed to indicate its completion.

A Manager with Employees at more than one location and/or changing locations can use the Timesly service to determine work arrival and leave times or task start and stop times as Timesly can be used on portable devices and set up to more than one device. A Manager can therefore have multiple devices at multiple locations and still receive confirmation of his or her Employees' work arrival and leave times or task start and stop times.

To set up Timesly, Managers will create a unique alphanumerical identifier that serves as a passcode for each Employee. Each Employee will then have a picture taken that is stored in Timesly's facial recognition software. Each Employee's unique facial features are then matched to the unique alphanumerical identifier.

When an Employee is to start work or a task, whether done at a consistent site that does not change or a site that changes constantly, the Employee can use Timesly to record his or her arrival and departure times or task start and end times. The Timesly application can be placed on a mobile device, a computer, or a tablet and either move freely or be secured to a wall. Whether the Timesly service is on a portable or stationary device, the Employee enters his or her unique alphanumerical identifier, then stands before the device to have his or her face scanned and recognized. Timesly will then immediately confirm whether the facial features match the unique alphanumerical identifier. As this confirmation works in real time, it records the confirmation as the Employee's work arrival time or task start time.

The use of GPS technology tracks the geographic location of the portable device on which Timesly is installed. Therefore, if the device is a mobile phone or tablet that can perform the facial recognition service at any location, the GPS technology can further confirm in real time the Employee's location at the intended work or task site if one exists.

When the Employee leaves the site, whether for a break from which he will return to the site or for the day, completes a task, or stops work on a task, he or she again enters his or her unique alphanumerical identifier, and then stands before the device to have his or her face scanned and recognized. Timesly will then immediately confirm whether the facial features match the unique alphanumerical identifier. As this confirmation works in real time, it records the confirmation as the Employee's departure time or task stop time. If that Employee has completed a task from the Tasks list, the Employee will access the list and indicate completion of the task. For each Employee, a time sheet is created for each payroll period that lists each the times of each clock in and clock out and the total number of hours and minutes worked per shift, per day, and per pay period.

By using Timesly and its facial recognition capabilities, a Manager is able to know when an Employee arrived and left a work site or started and stopped work on a task, whether at a particular work site or not. Timesly also enables the Manager to know the total number of hours and minutes the Employee worked or spent to complete a task from the “Tasks” list based on his or her start and stop times. This does away with the previous technology where an Employee used a punch in clock for work, physically inserting a card through a stationary system or swiping a card or key before a stationary machine to register arrival and departure times. The previous technology could not ensure that a particular Employee arrived and left a work site as stated on his or her time sheet because other fellow Employees could punch the card or swipe the key or card on his or her behalf. The previous technology also did not permit attendance verification of Employees and work or task time reconciliation from mobile work or task sites. Timesly also does away with self-reporting of time spent at work or on a task.

With Timesly, only the face that is registered with the unique alphanumerical identifier can successfully create work arrival and leave time entries or task start and stop time for that Employee. If the unique alphanumerical identifier at any point does not match the facial image provided by the Employee, the mismatch is noted, and the Manager will be notified of it. The Manager can then follow up and investigate to confirm whether the work arrival and leave time entries or task start and stop times were actually done by the Employee linked to the unique alphanumerical identifier.

With Timesly, Managers can also verify the work arrival and leave time entries or task start and stop times are all being entered at the designated location using GPS technology. If an Employee's work arrival and leave time entries or task start and stop times using the Timesly service do not match the geographical location designated for a specific site to perform work or a task, the mismatch is noted, and the Manager will be notified of it. The Manager can then follow up and investigate whether the work or task location associated with the work arrival and leave time entries or task start and stop times were actually done by the Employee at the intended location.

Facial recognition technology helps verify each Employee's work arrival and leave time entries or task start and stop times permitting internal monitoring to ensure accurate time keeping. With use of Timesly's GPS features, Managers can further monitor the accurate location for work arrival and leave time entries or task start and stop times on portable devices entrusted to his or her Employees and out of the Manager's sight. The real time verification that the work arrival and leave time entries or task start and stop times is done at a specific geographic location, if one exists, permits internal monitoring to ensure accurate time keeping at any site or location that a device with the Timesly service may be. The real time verification also permits the immediate creation of a thorough timesheet of each Employee's hours worked or Task completion time for a given pay period. This time sheet can then be sent directly to the Manager's payroll department.

It will be appreciated that variations of the above-disclosed and other features and functions, or alternatives thereof, may be desirable and combined into many other different systems or applications. Also, that various presently unforeseen or unanticipated alternatives, modifications, variations or improvements therein may be subsequently made by those skilled in the art which are also intended to be encompassed by the above description. Where methods and steps described above indicate certain events occurring in certain order, those of ordinary skill in the art having the benefit of this specification would recognize that the ordering of certain steps may be modified to be performed in different orders and/or in concurrently, and that such modifications are in accordance with the variations of the invention. Thus, the methods illustrated are not intended to be limited to a particular sequential order, particularly in instances in which certain steps may or may not be performed or may be performed simultaneously. In addition, embodiments of services, both basic and premium, are intended to exemplify alternatives, modifications, and equivalents that may fall within the scope of this specification.

1. A method for verifying an employee's work attendance and task completion, said method comprising the steps of:
facial recognition software storing an electronic image of the employee's face and recognizing distinct facial features of the employee;
a manager assigning a unique alphanumerical code to the electronic image of the employee's face;
the facial recognition software associating the electronic image of the employee's face and the distinct facial features with the unique alphanumerical code;
the manager assigning the employee to a work site or a task;
the employee entering the unique alphanumerical code into a stationary or portable device equipped with the facial recognition software and global positioning system technology upon the employee arriving to the work site or starting the task;
the device scanning the employee's face to create a real-time image of the employee's face upon the employee entering the unique alphanumerical code into the device;
the device confirming the real-time image of the employee's face matches the stored image of the employee's face that corresponds to the entered unique alphanumerical code;
the device recording the employee's arrival time to the work site or start time of the task upon confirming the employee's face matches the stored image of the image of the employee's face that corresponds to the entered unique alphanumerical code;
the employee entering the unique alphanumerical code into a device equipped with the facial recognition software and global positioning system technology upon the employee leaving the worksite or completing the task;
the device again scanning the employee's face to create a real-time image of the employee's face upon the employee leaving the worksite or completing the task and entering the unique alphanumerical code into the device;
the device again confirming the real-time image of the employee's face matches the stored image of the employee's face that corresponds to the entered unique alphanumerical code; and
the device recording the employee's leaving time of the work site or completion of the task upon confirming the employee's face matches the stored image of the image of the employee's face that corresponds to the entered unique alphanumerical code.

2. The method in claim 1 further comprising the step where upon the device confirming the real-time image of the employee's face matches the stored image of the employee's face that corresponds to the entered unique alphanumerical code, said device enabling the manager to learn the arrival time to and leave time from the work site or the start time and completion time of the task.

3. The method of claim 1 wherein the step of the manager assigning the employee a task includes the manager creating a list of tasks for the employee to complete that can be stored and displayed on the device and accessed by the employee.

4. The method of claim 3 further comprising the step where upon the employee's completion of a task from the list of tasks, the employee accessing the list stored and displayed on the device and indicating the completion of the task.

5. The method of claim 1 further comprising the step where upon the device scanning the employee's face to create a real-time image of the employee's face upon the employee entering the unique alphanumerical code into the device, the device notifying the manager in the event of the employee's face does not match the stored image of the employee's face that corresponds to the entered unique alphanumerical code.

6. The method of claim 1 wherein the device equipped with the facial recognition software and global positioning system technology is a portable device such that upon the employee entering the unique alphanumerical code into the device upon the employee's arrival to and leave from the work site or start of and completion of the task, the portable device notifying the manager of the geographical location of the device.

7. The method of claim 6 further comprising the step where upon the portable device notifying the manager of the geographical location of the device, the manager verifying that the employee entered the unique alphanumerical code into said portable device upon the employee's arrival to and leave from the work site or start of and completion of the task at the intended work or task site.
